(19) United States
(12) Patent Application Publication
(10) Pub. No.: US 2006/0114191 A1
(43) Pub. Date: Jun. 1, 2006

(54) Data driving circuit, organic light emitting display including the same, and driving method thereof

(76) Inventor: Sang Moo Choi, Suwon (KR)

Correspondence Address: CHRISTIE, PARKER & HALE, LLP, PO BOX 7068, PASADENA, CA, 91109-7068, US

(21) Appl. No.: 11/269,144

(22) Filed: Nov. 7, 2005

(30) Foreign Application Priority Data
Nov. 8, 2004 (KR) 10-2004-0090401

(51) Int. Cl. G09G 3/30

(52) U.S. Cl. 345/76

(57) ABSTRACT

A data driving circuit for an organic light emitting display and a method of driving the display where the number of wiring lines is reduced approximately in half as compared with the conventional schemes. The data driving circuit includes a shift register generating sampling signals in sequence, a sampling latch part sequentially storing data when the sampling signal is supplied, outputting some of the data in response to a first control signal, and outputting the rest of the data in response to a second control signal, a holding latch part receiving said some of the data in response to the first control signal, and receiving said rest of the data in response to the second control signal, and a digital-to-analog converter converting the data stored in the holding latch part into an analog data signal corresponding to a gradation level.

### CROSS-REFERENCE TO RELATED APPLICATION

This application claims priority to and the benefit of Korean Patent Application No. 2004-90401, filed on Nov. 8, 2004, in the Korean Intellectual Property Office, the entire content of which is incorporated herein by reference.

### FIELD OF THE INVENTION

The present invention relates to a data driving circuit, an organic light emitting display including the data driving circuit and a driving method for the display, where the data driving circuit has an improved wiring structure to secure design freedom and decrease the total size of the organic light emitting display.

### BACKGROUND OF THE INVENTION

Various flat panel displays have recently been developed as alternatives to a relatively heavy and bulky cathode ray tube (CRT) display. The flat panel displays include liquid crystal displays (LCD), field emission displays (FED), plasma display panels (PDP), organic light emitting displays, and the like.

Among the flat panel displays, the organic light emitting display can emit light by electron-hole recombination. The organic light emitting display has advantages of relatively fast response time and relatively low power consumption.

The organic light emitting display generates a data signal based on external data, and transmits the data signal to pixels, in order to display an image with desired brightness. To change the external data into the data signal, the organic light emitting display employs at least one data driving circuit.

FIG. 1 illustrates a sampling latch part 10 and a holding latch part 20 provided in a conventional data driving circuit. A sampling latch part 10 sequentially stores data Data corresponding to a sampling signal sequentially supplied from a shift register (not shown). For example, the sampling latch part 10 includes i sampling latches to store i data (where, i is a natural number). The storage size of each sampling latch corresponds to the bit size of the data Data. In the case where the data Data has k bits (where k is a natural number), the storage size of each sampling latch is set such that it may store a data Data of k bits.

The holding latch part 20 receives and stores the data Data from the sampling latch part 10 in response to an output enable signal SOE of an external source. In this case, the holding latch part 20 includes holding latches of the same number as the sampling latches, i.e., i holding latches. The storage size of each holding latch is also set such that it may store a data Data of k bits.

FIG. 2 illustrates a conventional wiring connection between the sampling latch part 10 and the holding latch part 20. For the sake of convenience, two sampling latches 10a, 10b and two holding latches 20a, 20b are illustrated in FIG. 2. Further, the data Data is assumed to have a size of 6 bits.

Each of the sampling latches 10a, 10b and the holding latches 20a, 20b has a storage size of 6 bits in order to store the data Data of 6 bits. Further, each sampling latch 10a, 10b and each holding latch 20a, 20b is coupled through six wiring lines in order to transmit the data Data of 6 bits.

In more detail, the first sampling latch 10a stores data Data of 6 bits supplied from outside sources when the sampling signal is supplied to the sampling latch 10a. After the first sampling latch 10a stores the data Data, the sampling signal is supplied to the second sampling latch 10b. Then, the second sampling latch 10b receives the sampling signal and stores the external data Data of 6 bits. The sampling latches 10a, 10b . . . 10i, provided in the sampling latch part 10 sequentially store the data Data in response to the sequentially supplied sampling signals.

After the sampling signals are supplied to all sampling latches provided in the sampling latch part 10, i.e., after the data Data is stored in the sampling latch pat 10, the SOE signal is supplied to all holding latches 20a, 20b . . . 20i, provided in the holding latch part 20. At this time, the first holding latch 20a receives the data Data of 6 bits from the first sampling latch 10a through six wiring lines provided between the first sampling latch 10a and the first holding latch 20a. Likewise, the second holding latch 20b receives the data Data of 6 bits from the second sampling latch 10b through six wiring lines provided between the first sampling latch 10a and the first holding latch 20a. The holding latches 20a, 20b . . . 20i, provided in the holding latch part 20 receive the data Data from the sampling latches 10a, 10b . . . 10i, when the SOE signals are supplied.

As described above, the conventional data driving circuit employs the sampling latch part 10 and the holding latch part 20 for receiving the external data Data. However, the conventional data driving circuit needs k wiring lines to couple each sampling latch with each holding latch to process a data of k bits. This causes the size of the data driving circuit to increase. For example, in the case where the data has a size of 6 bits and three hundred sampling latches are provided in the sampling latch part 10, eighteen hundred wiring lines are needed between the sampling latch part 10 and the holding latch part 20, increasing the size of the data driving circuit correspondingly. Using a large number of wiring lines between the sampling latch part 10 and the holding latch part 20 not only limits the design of the data driving circuit but also increases production cost.

### SUMMARY OF THE INVENTION

Accordingly, it is an aspect of the present invention to provide a data driving circuit, an organic light emitting display including the data driving circuit and a driving method for the display, where the data driving circuit has an improved wiring structure to secure design freedom and decrease the total size of the organic light emitting display.

The embodiments of the present invention provide a data driving circuit including a shift register part for generating sampling signals in sequence; a sampling latch part for sequentially storing data when the sampling signal is supplied, outputting some of the data in response to a first control signal, and outputting the rest of the data in response to a second control signal; a holding latch part for receiving said some of the data in response to the first control signal, and for receiving said rest of the data in response to the second control signal; and a digital-analog converter for converting the data stored in the holding latch part into an analog data signal corresponding to a gradation level of the data stored.

According to an embodiment of the invention, the sampling latch part includes a plurality of sampling latches of k bits to store data of k bits. Each two adjacent sampling latches share k wiring lines with each other to output the data. Further, the holding latch part includes a plurality of holding latches of k bits where each two adjacent holding latches share k wiring lines with each other for receiving the data.

An embodiment of the invention provides an organic light emitting display including a pixel portion having a plurality of pixels coupled to data and scan lines and emitting light corresponding to a data signal. In the organic light emitting display, a scan driver supplies scan signals to the scan lines in sequence, and a data driver including at least one data driving circuit, supplies the data signal to the data lines. Each data driving circuit includes a shift register for generating sampling signals in sequence and a sampling latch part for sequentially storing data when the sampling signal is supplied, outputting some of the data during a first period, and outputting the rest of the data during a second period that does not overlap with the first period. The data driving circuit also includes a holding latch part for receiving some of the data during the first period, and receiving the rest of the data during the second period, and a digital-analog converter converting the data stored in the holding latch part into an analog data signal corresponding to a gradation level of the external data.

According to an embodiment of the invention, the organic light emitting display further includes a timing controller to supply a first control signal to the sampling latch part and the holding latch part during the first period, and to supply a second control signal to the sampling latch part and the holding latch part during the second period. Further, the sampling latch part includes a plurality of sampling latches of k bits to store data of k bits (where, k is a natural number), two adjacent sampling latches sharing k wiring lines to output the data. Also, the holding latch part includes a plurality of holding latches of k bits, two adjacent holding latches sharing k wiring lines for receiving the data.

An embodiment of the invention provides a method of driving an organic light emitting display, including controlling a shift register to generate sampling signals in sequence, storing data in alternately arranged first and second sampling latches when the sampling signals are supplied, outputting the data stored in the first sampling latches in response to a first control signal, storing the data output from the first sampling latches in first holding latches in response to the first control signal, outputting the data stored in the second sampling latches in response to a second control signal, storing the data output from the second sampling latches in second holding latches arranged alternately with the first holding latches in response to the second control signal, converting the data stored in the first and second holding. latches into an analog data signal, and displaying a predetermined image based on the data signal.

According to an embodiment of the invention, the first and second control signals are supplied at different times. Further, the first and second sampling latches adjacent to each other output the data through the same wiring lines. Also, the first and second holding latches adjacent to each other receive the data through the same wiring lines.

An embodiment of the present invention provides a data driving circuit for an organic light emitting display and a method for driving the display where a pair of sampling latches and a pair of holding latches of the data driving circuit share wiring lines with each other to transmit data. As the pairs of sampling and holding latches share the wiring lines required for transmitting the data, the number of wiring lines is reduced approximately in half as compared with the conventional schemes, allowing design freedom for the data driving circuit and decreasing its production cost. Further, as the number of wiring lines is reduced, the size of the data driving circuit is decreased as compared with the conventional data driving circuit.

### BRIEF DESCRIPTION OF THE DRAWINGS

FIG. 1 illustrates a sampling latch and a holding latch provided in a conventional data driving circuit.

FIG. 2 illustrates a conventional wiring connection between the sampling latch and the holding latch.

FIG. 3 illustrates an organic light emitting display according to an embodiment of the present invention.

FIG. 4 is a block diagram of a data driving circuit according to an embodiment of the present invention.

FIG. 5 illustrates a wiring connection between a sampling latch part and a holding latch part according to an embodiment of the present invention.

FIG. 6 shows waveforms for driving the sampling latch part and the holding latch part according to an embodiment of the present invention.

FIG. 7 is a detailed circuit diagram of the sampling latch part and the holding latch part according to an embodiment of the present invention.

FIGS. 8A and 8B illustrate data transmission between the sampling latch part and the holding latch part according to an embodiment of the present invention.

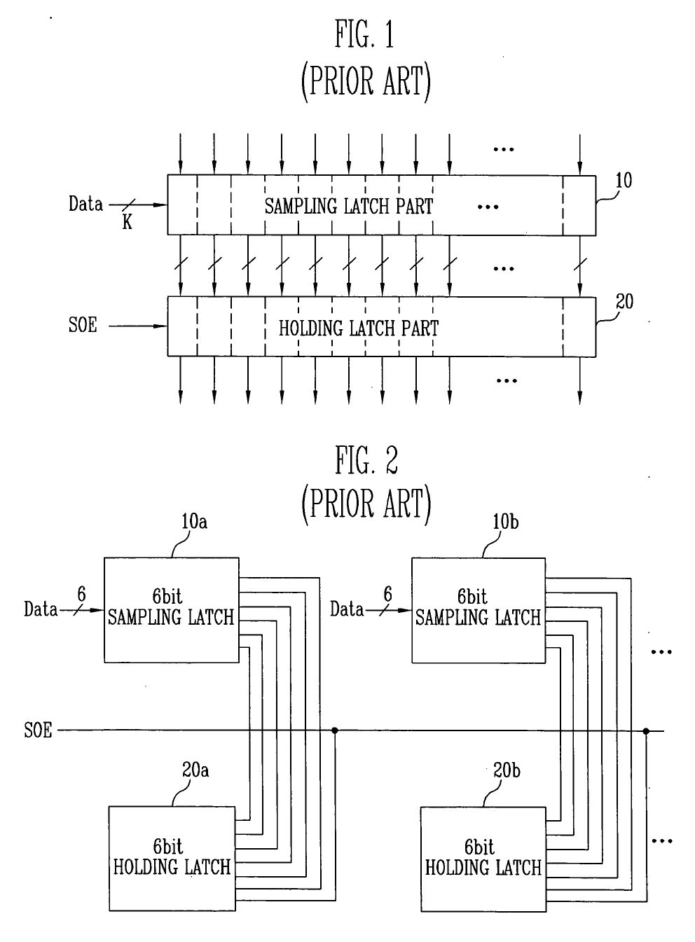

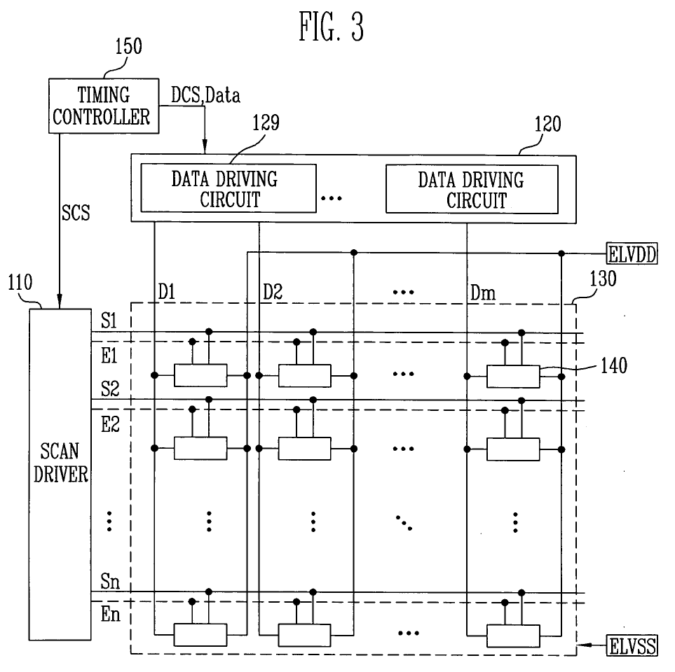

### DETAILED DESCRIPTION

FIG. 3 illustrates an organic light emitting display according to an embodiment of the present invention. An organic light emitting display according to an embodiment of the present invention includes a pixel portion 130 including a plurality of pixels 140 formed in regions where scan lines S1 through Sn intersect data lines D1 through Dm. The display also includes a scan driver 110 to drive the scan lines S1 through Sn, a data driver 120 to drive the data lines D1 through Dm, and a timing controller 150 to control the scan driver 110 and the data driver 120.

The scan driver 110 generates scan signals in response to a scan control signal SCS received from the timing controller 150, and supplies the scan signals to the scan lines S1 through Sn. The scan driver 110 also generates emission control signals in response to the scan control signal SCS, and supplies the emission control signals to emission control lines E1 through En.

The data driver 120 generates data signals in response to a data driving control signal DCS received from the timing controller 150, and supplies the data signals to the data lines D1 through Dm. The data driver 120 includes at least one data driving circuit 129. The data driving circuit 129 converts data Data, received from the timing controller 150, into the data signals and supplies the data signals to the data lines D1 through Dm.

The timing controller 150 generates the data and scan control signals DCS and SCS based upon external synchronization signals. The data control signals DCS are supplied to the data driver 120, and the scan control signals SCS are supplied to the scan driver 110. The timing controller 150 rearranges the external data Data and supplies the rearranged data to the data driver 120.

The pixel portion 130 receives a first voltage ELVDD and a second voltage ELVSS from external power sources. The first voltage ELVDD and the second voltage ELVSS are applied to each pixel 140, and cause the pixels 140 to display an image based on the data signal output from the data driving circuit 129.

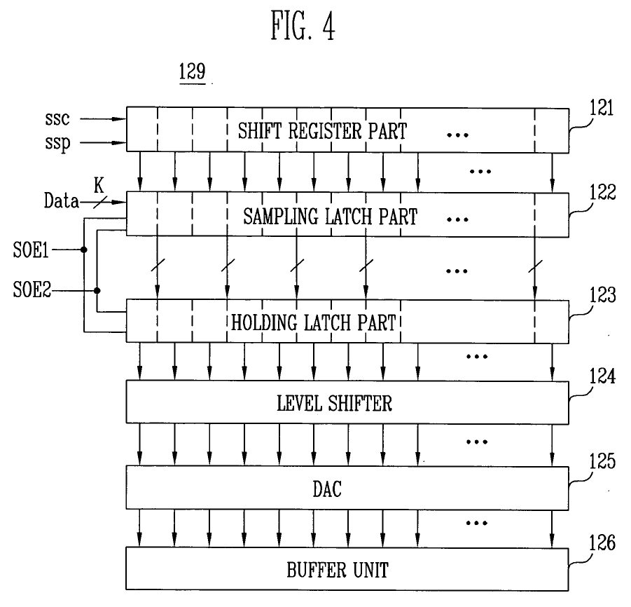

FIG. 4 is a block diagram of a data driving circuit 129 according to an embodiment of the present invention. The data driving circuit 129 of the present invention includes a shift register part 121 to sequentially generate the sampling signal, a sampling latch part 122 to sequentially store the data Data in response to the sampling signal, a holding latch part 123 to temporarily store the data Data stored in the sampling latch part 122 and at the same time to supply the data Data to a level shifter 124, the level shifter 124 to increase a voltage level of the data Data, a digital-analog converter (DAC) 125 to generate the data signal corresponding to a gradation level of the data Data, and a buffer unit 126 to temporarily store and then output the data signal.

The shift register part 121 includes i shift registers. The shift register part 121 receives a source shift clock SSC and a source start pulse SSP from the outside, and shifts the source start pulse SSP once per period of the source shift clock SSC. This operation generates i sampling signals in sequence.

The sampling latch part 122 sequentially stores the data Data in response to the sampling signals sequentially supplied from the shift register part 121. The sampling latch part 122 includes i sampling latches to store i data Data. Each sampling latch has a storage size corresponding to the bit size of the data Data. In the case where the data Data has k bits, the storage size of each sampling latch is set to store a data Data of k bits.

The sampling latch part 122 also receives a first source output enable signal SOE1 (or a first control signal) or a second source output enable signal SOE2 (or a second control signal) from the outside. The sampling latch part 122 transmits the data Data stored in some of the sampling latches to the holding latch part 123 when it receives the first source output enable signal SOE1. The sampling latches whose stored data Data is transmitted to the holding latch part 123 in response to the first source output enable signal SOE1 are referred to as a first sampling latch group. The sampling latch part 122 transmits the data Data stored in the rest of the sampling latches to the holding latch part 123 when it receives the second source output enable signal SOE2. The sampling latches whose stored data Data is transmitted to the holding latch part 123 in response to the second source output enable signal SOE2 are referred to as a second sampling latch group. The first source output enable signal SOE1 and the second source output enable signal SOE2 are supplied from the timing controller 150.

The holding latch part 123 receives and stores the data Data from the first sampling latch group in response to the first external source output enable signal SOE1. Further, the holding latch part 123 receives and stores the data Data from the second sampling latch group in response to the second external source output enable signal SOE2. Thus, the holding latch part 123 includes i holding latches which is as many holding latches as there are sampling latches in the sampling latch part 122. Like the sampling latch, the storage size of each holding latch is determined to store a data Data of k bits.

The level shifter 124 increases the voltage level of the data Data transmitted from the holding latch part 123, and then supplies it to the DAC 125. Supplying the data Data having a high voltage level, from the outside sources to the data driving circuit 129, requires circuit components suitable for the high voltage level and increases production cost. To reduce the production cost, the data Data having a low voltage level is supplied to the data driving circuit 129. The voltage level of the data Data is subsequently increased by the level shifter 124.

The DAC 125 generates the data signals corresponding to the bit number (or a gradation level ) of the data Data, and supplies the data signals to the buffer unit 126. To do so, the DAC 125 generates a voltage and/or a current corresponding to the gradation level of the data Data, and supplies the generated voltage and/or current as the data signal to the buffer unit 126.

The buffer unit 126 temporarily stores the data signals supplied from the DAC 125, and then supplies the data signals to the data lines D. The pixels 140 emit light corresponding to the data signals.

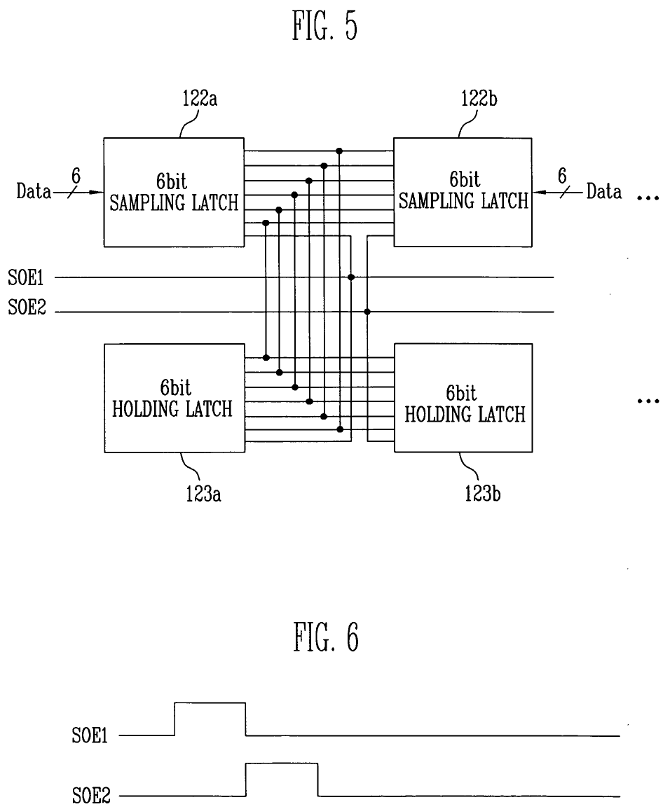

FIG. 5 illustrates a wiring connection between the sampling latch part 122 and the holding latch part 123 according to an embodiment of the present invention. For the sake of convenience, only two pairs of sampling and holding latches 122a, 122b, 123a, 123b are illustrated in FIG. 5. Further, the data Data is assumed to have a size of 6 bits.

In the data driving circuit 129, two adjacent sampling latches form a pair and share the same wiring lines for supplying the data Data to the holding latch part 123. Further, two adjacent holding latches form a pair and share the same wiring lines for receiving the data Data from the sampling latches. As a result, according to embodiments of the present invention, two pairs of sampling and holding latches 122a, 122b, 123a, 123b are coupled by k wiring lines where the conventional wiring connection needed 2k wiring lines.

Each of the two adjacent sampling latches 122a, 122b forming a pair, has a storage size corresponding to 6 bits in order to store a data Data of 6 bits. Similarly, each of the two adjacent holding latches 123a, 123b has a storage size corresponding to 6 bits in order to store a data Data of 6 bits. To transmit a data Data of 6 bits, six wiring lines are provided between the sampling latches 122a, 122b and the holding latches 123a, 123b. According to an embodiment of the present invention, the two sampling latches 122a, 122b share six wiring lines with the two holding latches 123a, 123b to transmit the data Data.

Between the sampling latches 122a, 122b forming a pair, the first sampling latch 122a receives the first source output enable signal SOE1, and the second sampling latch 122b receives the second source output enable signal SOE2. The first sampling latch 122a outputs the data Data when the first source enable signal SOE1 is supplied. Also, the second sampling latch 122b outputs the data Data when the second source enable signal SOE2 is supplied. The first and second source output enable signals SOE1, SOE2 are supplied at different times as shown in FIG. 6. Therefore, the first and second sampling latches 122a, 122b output the data Data at different times. In other words, the first and second sampling latches 122a, 122b are alternately activated.

Between the holding latches 123a, 123b forming a pair, the first holding latch 123a receives the first source output enable signal SOE1, and the second holding latch 123b receives the second source output enable signal SOE2. The first holding latch 123a receives the data Data when the first source enable signal SOE1 is supplied. Also, the second holding latch 123b receives the data Data when the second source enable signal SOE2 is supplied. Therefore, the first and second holding latches 123a, 123b output the data Data at different times. In other words, the first and second holding latches 123a, 123b are alternately activated.

According to an embodiment of the present invention, each sampling latch of the pair of sampling latches 122a, 122b outputs the data Data at a different time, and each holding latch of the pair of holding latches 123a, 123b receives the data Data at a different time. Further, the two pairs of sampling and holding latches 122a, 122b, 123a, 123b are coupled through k wiring lines. Consequently, the number of wiring lines provided between the sampling latch part 122 and the holding latch part 123 is reduced in half as compared with the conventional scheme. As the number of wiring lines provided between the sampling latch part 122 and the holding latch part 123 is reduced, the size of the data driving circuit 129 can be decreased. Further, the production cost of the data driving circuit 129 is reduced and the design freedom is achieved.

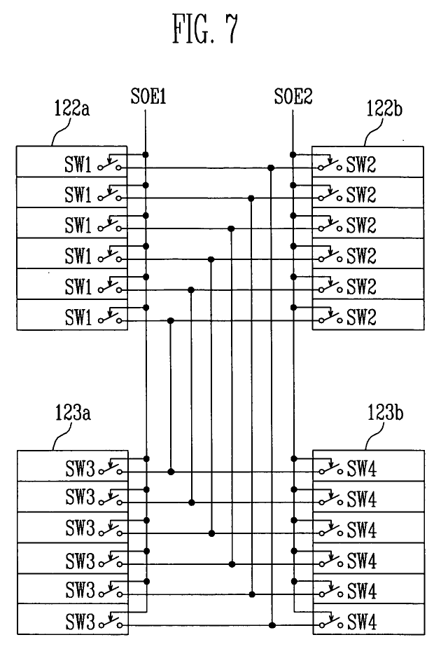

FIG. 7 is a detailed circuit diagram of the sampling latch part 122 and the holding latch part 123 according to an embodiment of the present invention. Each of the sampling latches 122a, 122b and the holding latches 123a, 123b includes six 1-bit latches.

In the first sampling latch 122a, each 1-bit latch includes a first switch SW1. The first switch SW1 is turned on when the first source output enable signal SOE1 is supplied from the outside.

In the second sampling latch 122b, each 1-bit latch includes a second switch SW2. The second switch SW2 is turned on when the second source output enable signal SOE2 is supplied from the outside.

In the first holding latch 123a, each 1-bit latch includes a third switch SW3. The third switch SW3 is turned on when the first source output enable signal SOE1 is supplied from the outside.

In the second holding latch 123b, each 1-bit latch includes a fourth switch SW4. The fourth switch SW4 is turned on when the second source output enable signal SOE2 is supplied from the outside.

Data transmission in the sampling and holding latches 122a, 122b, 123a, 123b is described with reference to FIG. 6. First, the first sampling latch 122a stores the data Data of 6 bits when the sampling signal is supplied. After the data Data is stored in the first sampling latch 122a, the sampling signal is supplied to the second sampling latch 122b. The second sampling latch 122b receives the sampling signal and stores the data Data of 6 bits. The sampling latches 122a, 122b provided in the sampling latch part 122 sequentially store the data Data in response to the sequentially supplied sampling signals.

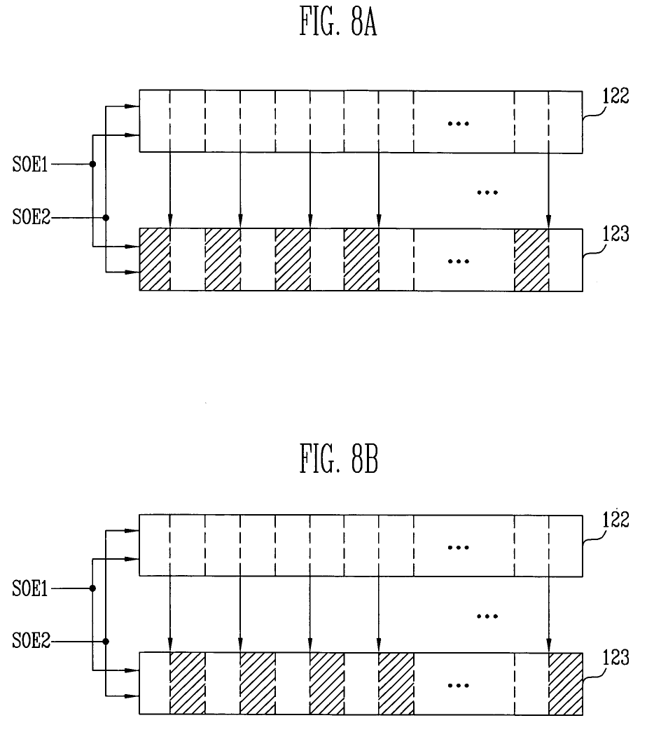

After the entire data Data is stored in the sampling latch part 122, the first source output enable signal SOE1 is supplied. Once the first source output enable signal SOE1 is supplied, the first and third switches SW1 and SW3 are turned on. Then, the data Data stored in the first sampling latch 122a is supplied to the first holding latch 123a. When the first source output enable signal SOE1 is supplied, the data Data is supplied to the first holding latches 123a among the holding latches forming pairs 123a, 123b (FIG. 8a).

Thereafter, the second source output enable signal SOE2 is supplied at a time different from the supplying time of the first source output enable signal SOE1. When the second source output enable signal SOE2 is supplied, the second and fourth switches SW2, SW4 are turned on. Then, the data Data stored in the second sampling latch 122b is supplied to the second holding latch 123b. When the second source output enable signal SOE2 is supplied, the data Data is supplied to the second holding latches 123b among the holding latches forming pairs 123a, 123b (FIG. 8b).

Thereafter, the data Data stored in the holding latch part 123 is converted into the data signal through the level shifter 124 and the DAC 125. The data signal is supplied to the data lines D via the buffer unit 126. Then, the pixel 140 emits light with a desired brightness and displays an image.

Although a few embodiments of the present invention have been shown and described, it would be appreciated by those skilled in the art that changes might be made to these embodiments without departing from the principles and spirit of the invention, the scope of which is defined in the claims and their equivalents.

What is claimed is:

1. A data driving circuit comprising:
a shift register part for generating sampling signals in sequence;
a sampling latch part for sequentially storing data when the sampling signals are supplied, for outputting some of the data in response to a first control signal, and for outputting the rest of the data in response to a second control signal;
a holding latch part for receiving and storing said some of the data in response to the first control signal and for receiving and storing said rest of the data in response to the second control signal; and
a digital-analog converter for converting the data stored in the holding latch part into a data signal corresponding to a gradation level of the data.

2. The data driving circuit of claim 1, wherein the sampling latch part comprises a plurality of sampling latches of k bits for storing data of k bits, where k is a natural number, and wherein each two adjacent sampling latches share k wiring lines to output the data.

3. The data driving circuit of claim 2, wherein the holding latch part comprises a plurality of holding latches of k bits, and wherein each two adjacent holding latches share k wiring lines to receive the data.

4. The data driving circuit of claim 3, wherein each of the plurality of sampling latches and each of the plurality of holding latches comprises k 1-bit latches.

5. The data driving circuit of claim 4, wherein each of the 1-bit latches of a first sampling latch between the two adjacent sampling latches comprises a first switch, the first switch turned on when the first control signal is supplied.

6. The data driving circuit of claim 4, wherein each of the 1-bit latches of a second sampling latch between the two adjacent sampling latches comprises a second switch, the second switch turned on when the second control signal is supplied.

7. The data driving circuit of claim 6, wherein each of the 1-bit latches of a first holding latch between the two adjacent holding latches comprises a third switch, the third switch turned on when the first control signal is supplied.

8. The data driving circuit of claim 7, wherein each of the 1-bit latches of a second holding latch between the two adjacent holding latches comprises a fourth switch, the fourth switch turned on when the second control signal is supplied.

9. The data driving circuit of claim 8, wherein the data stored in the first sampling latch of the two adjacent sampling latches is supplied to the first holding latch of the two adjacent holding latches when the first control signal is supplied, and the data stored in the second sampling latch is supplied to the second holding latch when the second control signal is supplied.

10. The data driving circuit of claim 1, wherein the first control signal and the second control signal are supplied at different times.

11. The data driving circuit of claim 1, further comprising:
a level shifter for increasing a voltage level of the data supplied from the holding latch part, the level shifter provided between the holding latch part and the digital-analog converter; and
a buffer unit for temporarily storing the data signals and for supplying the data signals to data lines, the buffer unit provided in an output terminal of the digital-analog converter.

12. An organic light emitting display comprising:
a pixel portion comprising a plurality of pixels, each pixel coupled to respective data and scan lines and emitting light corresponding to a respective data signal;
a scan driver for supplying scan signals to each of the scan lines in sequence;
a data driver comprising at least one data driving circuit for supplying the data signal to the data lines;
each data driving circuit comprising:
a shift register part for generating sampling signals in sequence;
a sampling latch part for sequentially storing data when the sampling signals are supplied, for outputting some of the data during a first period, and for outputting the rest of the data during a second period that does not overlap with the first period;
a holding latch part for receiving and storing said some of the data during the first period and for receiving and storing said rest of the data during the second period; and
a digital-analog converter for converting the data stored in the holding latch part into a data signal corresponding to a gradation level of the data.

13. The organic light emitting display of claim 12, further comprising a timing controller for supplying a first control signal to the sampling latch part and the holding latch part during the first period, and for supplying a second control signal to the sampling latch part and the holding latch part during the second period.

14. The organic light emitting display of claim 13, wherein the sampling latch part comprises a plurality of sampling latches of k bits for storing data of k bits, where, k is a natural number, and wherein each two adjacent sampling latches share k wiring lines to output the data.

15. The organic light emitting display of claim 14, wherein the holding latch part comprises a plurality of holding latches of k bits, and wherein each two adjacent holding latches share k wiring lines to receive the data.

16. The organic light emitting display of claim 15, wherein a first sampling latch between two adjacent sampling latches comprises at least one first switch, the first switch turned on in response to the first control signal for supplying the data to said k wiring lines.

17. The organic light emitting display of claim 16, wherein a second sampling latch between two adjacent sampling latches comprises at least one second switch, the second switch turned on in response to the second control signal for supplying the data to said k wiring lines.

18. The organic light emitting display of claim 17, wherein a first holding latch between two adjacent holding latches comprises at least one third switch, the third switch turned on in response to the first control signal for receiving the data from said k wiring lines.

19. The organic light emitting display of claim 18, wherein a second holding latch between two adjacent holding latches comprises at least one fourth switch, the fourth switch turned on in response to the second control signal for receiving the data from said k wiring lines.

20. The organic light emitting display of claim 12, further comprising:
a level shifter for increasing a voltage level of the data supplied from the holding latch part, the level shifter provided between the holding latch part and the digital-analog converter; and
a buffer unit for temporarily storing the data signal and for supplying the data signal to data lines, the buffer unit provided in an output terminal of the digital-analog converter.

21. A method of driving an organic light emitting display, the method comprising:
generating sampling signals in sequence;
storing data in first and second sampling latches in response to the sampling signals;
outputting the data stored in the first sampling latch in response to a first control signal;
storing the data output from the first sampling latch in a first holding latch in response to the first control signal;
outputting the data stored in the second sampling latch in response to a second control signal;
storing the data output from the second sampling latch in a second holding latch in response to the second control signal;
converting the stored data into an analog data signal; and
displaying a predetermined image based on the analog data signal.

22. The method of claim 21, wherein the first and second control signals are supplied at different times.

23. The method of claim 22, wherein first and second sampling latches output the data through same wiring lines.

24. The method of claim 22, wherein first and second holding latches receive the data through same wiring lines.
